(19) United States
(12) Patent Application Publication
(10) Pub. No.: US 2009/0048373 A1
(43) Pub. Date: Feb. 19, 2009

(54) Laser-markable flameproof molding compounds and laser-markable and laser-marked products obtained from said molding compounds

(76) Inventors: Joachim Clauss, Darmstadt-Eberstadt (DE); Hanno Huckstadt, Kelkheim (DE); Arnold Schneller, Seeheim-Jugenheim (DE); Klaus Kurz, Kelsterbach (DE)

Correspondence Address: Dearth, Miles B.;TICONA, 8040 Dixie Hwy, Florence, KY, 41042, US

(21) Appl. No.: 11/665,549

(22) PCT Filed: Oct. 15, 2005
(86) PCT No.: PCT/EP05/11099

§ 371 Date: Jul. 12, 2007

(30) Foreign Application Priority Data
Oct. 15, 2004 (DE) 10 2004 050 555.1

(51) Int. Cl. C08K 3/10; H05B 6/00; C08K 3/32; C08K 5/53; C08K 5/34; C08K 3/38

(52) U.S. Cl. 524/86; 264/400; 524/403; 524/406; 524/407; 524/413; 524/414; 524/133; 524/135; 524/126; 524/100; 524/405

(57) ABSTRACT

Novel halogen-free flame-retardant thermoplastic molding compositions are described, and give laser-markable moldings with increased quality of marking. The molding compositions comprise at least one thermoplastic A) and at least one light-sensitive compound of salt type B1) which within the polymer matrix when exposed to laser light changes its color or leads to a change in the color of the polymer matrix, and/or at least one light-sensitive or light-sensitizing oxide B2) which within the polymer matrix when exposed to laser light changes its color or leads to a change in the color of the polymer matrix, and at least one halogen-free compound or mixture C) which has a positive effect on the flammability and fire performance of the molding composition, and if appropriate, other conventional additives D).

The invention further relates to moldings produced from these laser-markable flame-retardant molding compositions, and also to laser-marked moldings produced therefrom. A process for laser marking is also disclosed, as is the use of the laser-markable, flame-retardant molding compositions for production of laser-marked moldings.

The present invention relates to novel molding compositions based on engineering thermoplastics, which have halogen-free flame retardancy and are also laser-markable. The invention also relates to moldings which are produced from these molding compositions.

Thermoplastics are materials with a long history of use. Functionalities such as markability by laser light are of increasing importance, alongside the mechanical, thermal, electrical, and chemical properties of these materials. Applications that may be mentioned by way of example are those in the household sector, in keyboards, and in the electronic sector. This application demands high contrast between the laser-inscribed marking and the polymer matrix as background.

The market has moreover increasing interest in thermoplastics with halogen-free flame retardancy. Substantial requirements here are placed upon the flame retardant: minimum intrinsic color, adequate thermal stability for incorporation into the polymer, and also effective flame retardancy of the flame retardant in reinforced and unreinforced polymer in the UL 94 fire test.

Flame-retardant polymers conventionally containing halogen generally comprise antimony-containing compounds as synergists, mostly antimony trioxide. These molding compositions intrinsically have sufficient laser-inscribability.

Thermoplastics having halogen-free flame retardancy generally have antimony-free formulations. It has not hitherto been possible to laser-inscribe these molding compositions with sufficient contrast.

Starting from the prior art mentioned, it is an object of the present invention to provide molding compositions which are based on engineering thermoplastics and which can be marked by conventional lasers, and which have halogen-free flame retardancy.

Surprisingly, suitable molding compositions have been found which comprise halogen-free flame retardants and metal salts, and in which the metal salts change their color on local irradiation with laser light via the energy introduced, or in which the energy introduced leads to a color change in the molding composition.

Suitable molding compositions have likewise been found, by combining halogen-free flame retardants with small amounts of antimony trioxide.

The present invention relates to laser-markable molding compositions having halogen-free flame retardancy and comprising
A) at least one thermoplastic and
B1) at least one light-sensitive compound of salt type which within the polymer matrix when exposed to laser light changes its color or leads to a change in the color of the polymer matrix, and/or
B2) at least one light-sensitive or light-sensitizing oxide which within the polymer matrix when exposed to laser light changes its color or leads to a change in the color of the polymer matrix, and
C) at least one halogen-free compound which has a positive effect on the flammability and fire performance of the molding composition, and
D) if appropriate, other conventional additives.

In the invention, the molding composition comprises, as polymer component (A), one or more thermoplastics. It is preferable that at least one of the polymer components is a semicrystalline or liquid-crystalline thermoplastic.

The invention uses, as component rendering the material laser-inscribable, light-sensitive compounds of salt type (B1) or light-sensitive or light-sensitizing oxides (B2), or mixtures of these, which, when mixed into component (A) and without irradiation, bring about no change, very little change, or a desired change in the color of the molding composition, and which, after irradiation of the molding composition, bring about a change in its lightness and, if appropriate, also its color, at the irradiated sites.

The invention uses, as flame-retardant component (C), phosphorus-containing compounds (C1), nitrogen-containing compounds (C2), hydroxy-containing compounds (C3), and also inorganic synthetic compounds or mineral products (C4), or suitable mixtures of these, which have a favorable effect on fire performance.

A feature of laser-inscribable flame-retardant molding compositions for the purposes of this application is that the radiation with intensive light, preferably from a conventional laser light source, a color change in comparison with the unirradiated matrix occurs at the radiated site. This color change can be discerned as a local difference in luminance, as a local difference in chromaticity coordinates, e.g. in the CIELab system, or as a local difference in chromaticity coordinates in the RGB system. These effects can occur with various light sources.

A feature of laser-inscribable flame-retardant molding compositions for the purposes of this application is that they achieve class V-2, V-1, or V-0 in the UL94 vertical fire test.

The inventive molding composition typically comprises from 20 to 99.95% by weight of thermoplastic polymer component (A).

Polymers that can be used in the matrix are not only those having linear chain molecules but also branched or slightly crosslinked polymers. The degrees of polymerization of the thermoplastics that can be used in the invention are not subject to any particular restriction, and are of the same order of magnitude as those of comparable molding compositions that are not inscribable by light.

Examples of thermoplastics that can be used with preference in (A) are polyacetals (A1), polyesters inclusive of polycarbonates (A2), polyamides (A3), polyarylene ethers and polyarylene sulfides (A4), polyether sulfones and polysulfones (A5), polyaryl ether ketones (A6), polyolefins (A7), liquid-crystalline polymers (A8), and also, if appropriate, other thermoplastic polymers as partners in a blend (AX).

For the purposes of this description, polyacetals (A1) are polymers whose main repeat unit is oxymethylene groups (—CH₂O—). These encompass polyoxymethylene homopolymers, polyoxymethylene copolymers, polyoxymethylene terpolymers, and polyoxymethylene block copolymers.

For the purposes of this description, polyesters (A2) are thermoplastic polymers having repeat ester groups in the main chain. Examples are polycondensates of naphthalenedicarboxylic acids, terephthalic acid, isophthalic acid, adipic acid, azelaic acid, sebacic acid, dodecanedioic acid, cyclohexanedicarboxylic acids, mixtures of these carboxylic acids, and ester-forming derivatives with dihydric alcohols, such as ethylene glycol, 1,3-propanediol, 1,4-butanediol, 1,4-butenediol, and 1,6-hexanediol, 1,4-hexanediol, 1,4-cyclohexanediol, 1,4-di(hydroxymethyl)cyclohexane, bisphenol A, neopentyl glycol, oligo- or polyethylene glycols, oligo- or polypropylene glycols, oligo- or poly(tetramethylene) glycols, mixtures of these diols, and also ester-forming derivatives of the same, and also with other possible AA, BB, and AB comonomers. For the purposes of this invention, the term polyesters is intended to include polycarbonates, these being obtainable via polymerization of aromatic dihydroxy compounds, in particular bis(4-hydroxyphenyl)-2,2-propane (bisphenol A) or its derivatives, e.g. with phosgene. Corresponding products are known per se and are described in the literature, and many of them are also commercially available.

Particularly preferred matrix components (A) are polyethylene terephthalate, polybutylene terephthalate, and polyetherester block copolymers.

For the purposes of this description, polyamides (A3) are thermoplastic polymers having repeat amide groups in the main chain. They encompass not only homopolymers of aminocarboxylic acid type but also those of the diamine-dicarboxylic acid type, and also copolymers with other possible M, BB, and AB comonomers. The polyamides that can be used are known and are described by way of example in Encyclopedia of Polymer Science and Engineering, Vol. 11, pp. 315-489, John Wiley & Sons, Inc. 1988.

Examples of polyamides (A3) are polyhexamethyleneadipamide, poly-hexamethyleneazelamide, polyhexamethylenesebacamide, polyhexa-methylenedodecanediamide, poly-11-aminoundecanamide, and bis(p-aminocyclohexyl)methanedodecanediamide, or the products obtained via ring-opening of lactams, e.g. polycaprolactam or polylaurolactam. Other suitable polyamides are those based on terephthalic or isophthalic acid as acid component and/or trimethylhexamethylenediamine or bis(p-aminocyclohexyl)propane as diamine component, and also polyamide parent resins prepared via copolymerization of two or more of the abovementioned polymers or their components. An example that may be mentioned of these is a copolycondensate composed of terephthalic acid, isophthalic acid, hexamethylenediamine, and caprolactam.

For the purposes of this description, polyarylene sulfides (A4) are thermoplastic polymers having repeat sulfur groups in the substantially aromatic main chain. They encompass not only homopolymers but also copolymers.

For the purposes of this description, liquid-crystalline polymers (A8) are in particular p-hydroxybenzoic acid- and/or 6-hydroxy-2-naphthoic acid-based liquid-crystalline copolyesters and copolyesteramides. Liquid-crystalline plastics to be used with very particular advantage are generally fully aromatic polyesters which form anisotropic melts and have average molar masses (Mw=weight average) of from 2000 to 200 000 g/mol, preferably from 3500 to 50 000 g/mol, and in particular from 4000 to 30 000 g/mol. Particularly suitable liquid-crystalline polymers are described by way of example in Saechtling, Kunststoff-Taschenbuch [Plastics Handbook], Hanser-Verlag, 27th Edition, on pages 517-521.

For the purposes of this description, thermoplastic polymers as partners (AX) in a blend can be any desired other semicrystalline, liquid-crystalline, and amorphous polymers.

For the purposes of this description, light-sensitive compounds (B1) are organic or inorganic compounds of salt type, where these, on exposure to a laser-light source, change their color and, respectively, lead to a color change in the plastic, at the irradiated site, and where these contain cations of which at least one is selected from the group consisting of Ti, Cr, Mn, Fe, Co, Ni, Cu, Zn, Y, Zr, Nb, Mo, Ag, Sn, Sb, La, Pr, Ta, W, Ce.

The compounds (B1) can be traditional salts with defined stoichiometry but they can also involve compounds of non-stoichiometric constitution.

For a given system of anions, occurrence of ion-exchanger functionality is possible evidence that complex structures of this type have been formed, incorporating two or more different cations.

In one possible embodiment of the invention, a mixed salt is used, having at least two different cations. Elements whose cations can complement the abovementioned cations are elements of the 3rd-6th Periods of main group II and III, the 5th-6th Periods of main group IV, or else the 4th-5th Periods of transition group III-VIII, or of the lanthanoids, or else elements from the 2nd-5th Periods of main group I.

In another possible embodiment of the invention, a mixture of salts is used which on heating can be reacted to give at least one compound having two cations.

There are in principle no restrictions placed upon the anions of component (B1), as long as they permit construction of compounds having the stated cations, and permit interaction of the compound with light.

It is preferable that component (B1) uses anions which contain at least two different elements.

Particularly preferred components (B1) have, as anions, inorganic oxo anions, or else the anions of the organic carboxylic acids, or of carbonic acid. Particularly preferred components (B1) have phosphorus-containing oxo anions as anions.

Combinations in which the unirradiated compound (B1) absorbs in the region of the wavelength of light used are preferred.

Preference is further given to combinations in which the intrinsic color of the unirradiated compound (B1) can be adjusted by way of different scattering behavior and absorption behavior, via variation of the particle size and constitution.

In one preferred embodiment of the inventive composition, the anions of component (B1) have the formula AₐOₒ(OH)_{y}^{z-}, where

A=tri- or pentavalent phosphorus, tetra- or hexavalent sulfur, tetravalent molybdenum, or hexavalent tungsten,
a, o, and z, independently of one another, are whole numbers with values from 1 to 20, and
y is a whole number with values from 0 to 10.

In one preferred embodiment of the inventive composition, component (B1) has anions of phosphorus(V) acid and/or of phosphorus(III) acid and/or of sulfur(IV) acid and/or of sulfur(VI) acid, and/or condensates thereof. In another preferred embodiment, component (B1) contains, as cations, Cu, Sn, Fe, or Sb, or a mixture of the same. Hydroxide ions and water can also be present, if appropriate.

For the purposes of this application, light-sensitive oxides (B2a) are inorganic particulate oxides which change their color on exposure to light. Light-sensitizing oxides (B2b) for the purposes of this application are inorganic, particulate oxides which on exposure to light promote formation of colorant compounds in the surrounding polymer matrix. The color change in formulations with oxides (B2) can either be a change of intrinsic color of these oxides or else can involve a catalytic contribution to the effect that appropriately absorbent compounds are formed in their immediate vicinity.

For the purposes of this application, the term oxides includes compounds in which some of the oxygen atoms are present in the form of hydroxy groups. In this case, too, the compounds can be of stoichiometric or non-stoichiometric constitution.

Suitable inorganic oxides of component (B2) can be based on elements of the 3rd-6th Periods of main group III and IV, the 5th-6th Periods of main group V, or else the 4th-5th Periods of transition group III-VIII, or on the lanthanoids.

Examples of these oxides (B2) are Al₂O₃, SiO₂, silicatic or aluminosilicatic minerals, silicatic glasses, TiO₂, ZnO, ZrO₂, SnO₂, Sb₂O₃, Sb₂O₅, Bi₂O₃, and also, if appropriate, of their mixed oxides with other doping elements. Particular preference is given to Sb₂O₃ and TiO₂ in anatase and rutile form.

Physical parameters, such as the particle size of components B1) and B2), alongside chemical constitution, have a decisive effect on the quality of laser-inscribability. If the scattering behavior of the additive causes it to act as white pigment, the lightness coordinates are increased. Furthermore, the average particle size is a measure of the maximum particle-matrix interface which can be achieved, given good dispersion, and therefore also affects the sensitivity of the molding composition to light.

Components B1) and B2) with an average particle diameter of less than 10 μm have proven suitable. Components B1) and B2) preferably have an average particle diameter below 5 μm.

Quantitative particle size data in this application are always based on the average particle size (d₅₀) and on the particle size of the primary particles. For the purposes of this invention, particle diameter is determined by conventional methods, such as light scattering (if appropriate with polarized light), microscopy or electron microscopy, or flow-counting methods at narrow gaps, sedimentation methods, or other commercially available methods.

In one embodiment of the invention, the unirradiated component B1) and/or B2) has any desired intrinsic color, and the irradiated component B1) and/or B2) exhibits a color change which is as marked as possible when compared therewith. The term color difference used here can mean a change from one hue to another, for example from yellow to red. However, for the purposes of the invention, this term is also intended to mean a change in lightness, for example from white to gray, from gray to black, or from pale brown to dark brown. The term color difference is also intended to mean a change in opacity, for example from transparent to white or black or brown.

The color difference can be perceived by the human eye. The invention is likewise intended to include color differences that are detected by optical measurement equipment or those perceived by means of a detector at a wavelength outside the range of sensitivity of the human eye. An example that may be mentioned of this is the use of readers which use diode lasers in the NIR region.

For the visible light region, the CIELab system can clearly be used to describe the color difference. Here, high color contrast means occurrence of a high value for dE*, where

$${dE}^{*} = \sqrt[2]{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}}$$

Index 1 here represents the unirradiated molding composition, and index 2 here represents the irradiated molding composition.

The CIELab system is a color space specified in 1976 by the Commission Internationale d'Eclairage, where L*=lightness, a*=red-green color data, and b*=yellow-blue data.

In one preferred embodiment of the invention, the unirradiated component B1) and/or B2) has maximum lightness (i.e. maximum lightness coordinate L* in the CIELab color space) and minimum intrinsic color (i.e. minimum deviation from the black-white axis: in quantitative terms minimum a*, minimum b*). The intention in this case is that the irradiated component B1) and/or B2) have minimum lightness (minimum lightness coordinate L*) and nevertheless minimum intrinsic color (in quantitative terms minimum a*, minimum b*).

In another preferred embodiment of the invention, the unirradiated component B1) and/or B2) has maximum lightness (maximum lightness coordinate L in the CIELab color space) and minimum intrinsic color (minimum deviation from the black-white axis: in quantitative terms minimum a*, minimum b*). In this case, the intention is that the intrinsic color of the irradiated component B1) and/or B2) be as marked as possible (maximum a* and/or b*).

There are in principle no restrictions on the wavelength ranges of the laser light used. A wavelength of suitable lasers is generally in the range from 157 nm to 10.6 μm, preferably in the range from 532 nm to 10.6 μm.

By way of example, mention may be made here of CO₂ lasers (10.6 μm) and Nd.YAG lasers (1064 nm), or pulsed UV lasers.

The wavelengths of typical excimer lasers are as follows: F₂ excimer lasers (157 nm), ArF excimer lasers (193 nm), KrCl excimer lasers (222 nm), KrF excimer lasers (248 nm), XeCl excimer lasers (308 nm), XeF excimer lasers (351 nm), frequency-multiplied Nd:YAG lasers with wavelengths of 532 nm (frequency-doubled), of 355 nm (frequency-tripled), or 265 nm (frequency-quadrupled).

It is particularly preferable to use Nd:YAG lasers (1064 or 532 nm) and CO₂ lasers.

The energy densities of the lasers used in the invention are generally in the range from 0.3 mJ/cm² to 50 J/cm², preferably from 0.3 mJ/cm² to 10 J/cm². If pulsed lasers are used, the pulse frequency is generally in the range from 1 to 30 kHz.

The inventive molding composition typically comprises from 0.1 to 10% by weight of component B1), preferably from 0.1 to 3% by weight, particularly preferably from 0.2 to 2% by weight. At lower contents, the inscription contrast is below the adequacy threshold. Higher contents are uneconomic and can impair the color of the matrix.

The inventive molding composition typically comprises from 0.1 to 20% by weight of component B2), preferably from 0.5 to 10% by weight, particularly preferably from 0.8 to 4% by weight. At lower contents, the inscription contrast is below the adequacy threshold; at higher contents, it is difficult to achieve the mechanical properties desired in the molding composition.

Phosphorus-containing compounds (C1) for the purposes of this application are organic and inorganic compounds containing phosphorus, in which the valency of phosphorus is from −3 to +5. Examples are aromatic phosphines, aromatic diphosphines, substituted phosphine oxides, the various forms of elemental phosphorus, hypophosphites of salt type, or organic esters of hypophosphorous acid, phosphites of salt type or organic esters of phosphorous acid, hypodiphosphates, phosphates of salt type or organic esters of phosphoric acid. EP 0932643 mentions other non-restricting examples of suitable phosphorus compounds.

One preferred embodiment of the invention uses, as phosphorus-containing compound (C1), salts of the phosphinic acid of formula (I) or salts of the dimerized or polymerized phosphinic acid of formula (II), or a mixture of the same. EP 00892829 mentions relevant examples.

Preferred phosphinic salts used are compounds having the structural element of the formula (I)

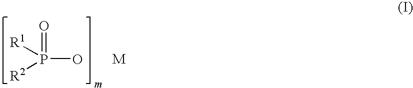

in which R¹ and R², independently of one another, are hydrogen, alkyl, cycloalkyl, aryl, or aralkyl, M is an m-valent metal ion, preferably an alkali metal ion or alkaline earth metal ion, or an ion of a metal of the 3rd main group of the Periodic Table of the Elements, and m is a whole number from 1 to 6, preferably from 1 to 3, and in particular 2 or 3.

Diphosphinic salts used are preferably compounds having the structural element of the formula (II)

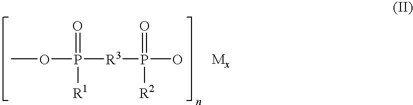

in which R¹ and R², independently of one another, are hydrogen, alkyl, cycloalkyl, aryl, or aralkyl, and R³ is alkylene, cycloalkylene, arylene, or aralkylene, M is an m-valent metal ion, preferably an alkali metal ion or alkaline earth metal ion, or an ion of a metal of the 3rd main group of the Periodic Table of the Elements, n is a whole number from 1 to 6, preferably from 1 to 3, and in particular 2 or 3, and x is 1 or 2.

If R¹ and/or R² are alkyl, these are generally saturated monovalent alkyl radicals having from 1 to 20 carbon atoms. The alkyl radicals may be straight-chain or branched radicals. Preference is given to straight-chain alkyl radicals having from 1 to 6 carbon atoms. Particular preference is given to methyl and/or ethyl.

If R¹ and/or R² are cycloalkyl, these are generally saturated monovalent cycloalkyl radicals having from five to eight, preferably five or six, ring carbon atoms. Preference is given to cyclopentyl or cyclohexyl.

If R¹ and/or R² are aryl, these are generally monovalent aromatic hydrocarbon radicals having one or two aromatic rings. Phenyl is preferred.

If R¹ and/or R² are aralkyl, these are generally monovalent aromatic hydrocarbon radicals having one or two aromatic rings, these moreover having an alkylene chain. Benzyl is preferred.

R³ can be an alkylene radical. This is usually a group of the formula —CₙH₂ₙ— in which n is a whole number from one to ten, preferably from two to six. These can be straight-chain or branched saturated divalent hydrocarbon radicals. Examples of these are ethylene, propylene, butylene, and hexylene. These radicals can also have interruption by heteroatoms, such as nitrogen, sulfur, or oxygen. Examples here are divalent radicals of di-, tri-, or tetraethylene glycol, after removal of the terminal hydroxy groups.

If R³ is cycloalkylene, this is generally a saturated divalent cycloalkyl radical having from five to eight, preferably five or six, ring carbon atoms. Preference is given to cyclopentylene or cyclohexylene.

If R³ is aryl, this is generally a divalent aromatic hydrocarbon radical having one or two aromatic rings. Phenylene is preferred.

If R³ is aralkylene, this is generally a divalent aromatic hydrocarbon radical having one or two aromatic rings and moreover having an alkylene chain. Benzylene is preferred.

The radicals R¹ to R³ mentioned can moreover also bear inert substituents, e.g. alkyl or alkoxy radicals preferably having from one to six carbon atoms, other examples being halogen atoms, such as chlorine.

M is a cation of a metal, preferably of a metal of the 1st, 2nd, or 3rd main group of the Periodic Table of the Elements.

Preferred examples of M are cations of lithium, of sodium, of potassium, of magnesium, of calcium, of strontium, of barium, and of aluminum. Particular preference is given to calcium and/or aluminum.

In another embodiment of the invention, organophosphorus compounds, such as resorcinol tetraphenyl diphosphate, are used as phosphorus-containing compounds (C1).

In another preferred embodiment of the invention, mixtures comprising phosphinic salts and organophosphorus compounds, such as resorcinol tetraphenyl diphosphate, are used as phosphorus-containing compounds (C1).

The inventive molding composition typically comprises from 0 to 40% by weight of phosphorus-containing component (C1), preferably from 5.0 to 30% by weight, particularly preferably from 10 to 25% by weight.

For the purposes of this application, nitrogen-containing compounds (C2) are organic and inorganic nitrogen-containing compounds. Suitable flame-retardant additives are mostly heterocyclic compounds having at least one nitrogen atom as heteroatom, adjacent either to an amino-substituted carbon atom or to a carbonyl group. Examples of these are pyridazine, pyrimidine, pyrazine, pyrrolidone, aminopyridine, and compounds derived therefrom.

Advantageous compounds (C2) are aminopyridines or aminotriazines and compounds derived therefrom, e.g. melamine, 2,6-diaminopyridine, substituted and dimeric aminopyridines, and mixtures prepared from these compounds.

Further advantageous compounds (C2) are polyamides and dicyandiamide, urea and its derivatives, and also pyrrolidone and compounds derived therefrom. Examples of suitable pyrrolidones are imidazolidinone and compounds derived therefrom, e.g. hydantoin, allantoin, and its derivatives.

Further particularly advantageous compounds (C2) are triamino-1,3,5-triazine (melamine) and its derivatives, e.g. melamine-formaldehyde condensates and methylolmelamine.

Melamine cyanurate is particularly preferably used as component (C2). This is a reaction product of preferably equimolar amounts of melamine and cyanuric acid or isocyanuric acid. By way of example, it is obtained via reaction of aqueous solutions of the starting compounds at from 90 to 100° C. The product available commercially is a white powder with an average grain size d₅₀ of from 1.5 to 7 μm.

Further suitable melamine derivatives (also often termed salts or adducts) are the condensates of melamine (melem (dimer), melam (trimer), or higher oligomers), melamine borate and oxalate, primary or secondary melamine phosphate, and secondary melamine pyrophosphate, melamine neopentyl glycol borate, and also polymeric melamine phosphate (CAS No. 56386-64-2).

Further suitable nitrogen-containing compounds (C2) are guanidine derivatives, e.g. cyanoguanidine, guanidine carbonate, guanidine cyanurate, primary and secondary guanidine phosphate, primary and secondary guanidine sulfate, guanidine pentaerythritol borate, guanidine neopentyl glycol borate, and also urea phosphate, urea cyanurate, ammeline and ammelide.

Further suitable nitrogen-containing compounds (C2) are benzoguanamine itself and its adducts and, respectively, salts, and also its derivatives substituted at nitrogen and their adducts and, respectively, salts.

Other suitable compounds are benzoguanamine compounds, allantoin compounds, or glycolurils, and in particular their adducts with phosphoric acid, boric acid and/or pyrophosphoric acid.

Particularly preferred nitrogen-containing compounds (C2) are melamine cyanurate, melamine phosphate, and melamine polyphosphate.

The inventive molding composition typically comprises from 0 to 30% by weight of nitrogen-containing component (C2), preferably from 2.0 to 20% by weight, particularly preferably from 3 to 10% by weight.

For the purposes of this application, compounds (C3) containing hydroxy groups are alcohols and polyol compounds which can be used as flame-retardant additives or synergists. Examples are aliphatic di- to hexahydric alcohols, such as alkylene glycols, e.g. ethylene glycol, diethylene glycol, triethylene glycol, propylene glycol or butylene glycol, polyalkylene glycols, such as polyethylene glycols, polypropylene glycols, or polybutylene glycols, glycerol, trimethylolpropane, erythritol, neopentyl glycol, pentaerythritol, pentitols, such as xylitol, hexitols, such as sorbitol and dulcitol. Alongside these, it is also possible to use cyclic polyhydroxy compounds, e.g. monosaccharides and/or disaccharides and/or derivatives of these, such as sucrose hexaisobutyrate. It is also possible to use partially esterified or ethoxylated derivatives of polyhydroxy compounds. Examples of these are glycerol monostearate or sorbitol monostearate, ethoxylated dimethylolpropane, ethoxylated pentaerythritol, dipentaerythritol or ditrimethylolpropane, and also lauryl, hexadecyl, or stearyl esters with carbohydrates, such as sorbitan. Other examples are organic polymers containing hydroxy groups, e.g. polyvinyl alcohol, inclusive of the copolymers with other monomers copolymerizable therewith, such as alpha-olefins, e.g. ethylene, poly(2-hydroxyethyl-methyl methacrylate), poly(hydroxystyrene), poly(hydroxyalkyl acrylate) and poly(hydroxyalkyl methacrylate), inclusive of the comonomers with other monomers copolymerizable therewith, such as other (meth)acrylic esters, or phenol-formaldehyde resins, e.g. novolaks, or epoxy resins containing hydroxy groups, polysaccharides, such as cellulose or starch, and copolymers containing hydroxy groups, such as poly(ethylene-co-vinyl alcohol).

Preferred components (C3) are polyvinyl alcohol, sorbitol monostearate, and poly(ethylene-co-vinyl alcohol).

The inventive molding composition typically comprises from 0 to 20% by weight of component (C3) containing hydroxy groups, preferably from 0 to 15% by weight, particularly preferably from 0 to 10% by weight.

For the purposes of this application, inorganic synthetic compounds or mineral products (C4) encompass oxygen compounds of silicon, oxides or salts of magnesium, calcium, aluminum, zinc, and also stannates and borates.

Examples of oxygen compounds of silicon are salts and esters of orthosilicic acid and condensates thereof (silicates). An overview of suitable silicates is given by way of example in Riedel, Anorganische Chemie [Inorganic Chemistry], 2nd Edn., pp. 490-497, Walter de Gruyter, Berlin-N.Y. 1990. Compounds of particular interest here are phyllosilicates, such as talc, kaolinite, and mica, and the group of the bentonites and montmorillonites, and also tectosilicates, e.g. the group of the zeolites. Alongside these, it is also possible to use silicon dioxide in the form of fine-particle silicic acid.

The silicic acid here can have been prepared by a pyrogenic process or by a solution-chemistry process. The silicates or silicic acids mentioned can have been equipped with organic modifiers, if appropriate, in order to achieve certain surface properties.

Other examples of oxygen compounds of silicon are glass powders, glass-ceramic powders, and ceramic powders of varying constitution, for example those described in “Ullmann's Encyclopedia of Industrial Chemistry”, 5th Edition, Vol. A 12 (1989), pp. 372-387 (glass) or pp. 443-448 (glass-ceramic). Appropriate ceramic materials are described on pp. 12-18 (Commercial Ceramic Clays) in Vol. 6 (1986). It is possible to use either glasses and/or ceramics with defined melting point or else mixtures of products with a broad melting range, such as the ceramic frits used for production of glazes. These frits or mixtures of two or more frits can also additionally comprise glass fibers, basalt fibers, or ceramic fibers. Mixtures of this type are described by way of example in EP 0 287 293 B1.

Examples of suitable inorganic compounds (C4) are magnesium compounds, such as magnesium hydroxide, and also hydrotalcites of the formula Mg₍₁₋ₐ₎Ala(OH)₂An_{a/2}.pH₂O, where An is the anions SO₄²⁻ or CO₃²⁻, a is greater than 0 and smaller than or equal to 0.5, and p is the number of water molecules in the hydrotalcite and is a value from 0 to 1.

Hydrotalcites in which An is the anion CO₃²⁻, and in which 0.2≦a≦0.4 are preferred. The hydrotalcites can either be natural hydrotalcites, which may, if appropriate, have been modified via appropriate chemical treatment, or else synthesized products.

Further examples of suitable inorganic compounds (C4) are metal carbonates of metals of the second main group of the Periodic Table of the Elements, and mixtures of these. Suitable compounds are magnesium calcium carbonates of the formula Mg_{b}Ca_{c}(CO₃)_{b+c}.qH₂O, where b and c are numbers from 1 to 5, b/c≧1, and q≧0, and also basic magnesium carbonates of the formula Mg_{d}(CO₃)ₑ(OH)_{2d-2e}.rH₂O, where d is a number from 1 to 6, e is a number greater than 0 and smaller than 6, and d/e>1, and r≧0. Mixtures of the carbonates are likewise suitable. The magnesium calcium carbonates and basic magnesium carbonates can be used either in hydrous form or else in anhydrous form, and with or without surface treatment. Among these types of compounds are the naturally occurring minerals such as huntite and hydromagnesite, and mixtures of these.

Further examples of suitable inorganic compounds (C4) are zinc compounds, such as zinc oxide, zinc stannate, zinc hydroxystannate, zinc phosphates, and zinc sulfides, and also zinc borates of the formula f ZnO.g B₂O₃.h H₂O, where f, g, and h are values from 0 to 14.

Further examples of suitable inorganic compounds (C4) are metal borates of metals of the first, second, and third main group, and also the second transition group of the Periodic Table of the Elements, and mixtures of these. Particularly suitable compounds are the magnesium, calcium, aluminum, and zinc borates of the formula i MgO.k CaO.l Al₂O₃.m ZnO.n B₂O₃.oH₂O, where i, k, l, m, n, and o are numbers from 1 to 14. The borates can be used either in hydrous form or else in anhydrous form. Among these types of compound are also naturally occurring minerals, such as colemanite, and mixtures of these. Mixtures of the synthetic borates are likewise suitable, as also are mineral compounds substantially corresponding to these.

The inventive molding composition typically comprises from 0 to 30% by weight of inorganic compounds (C4), preferably from 0 to 20% by weight, particularly preferably from 0 to 10% by weight.

The inventive molding composition comprises from 1 to 50% by weight, preferably from 5 to 30% by weight, of at least one of the flame-retardant components (C1) to (C4). Lower contents do not generally give the desired flame-retardant effect. Higher contents do not generally achieve the mechanical properties desired in the molding composition.

Other conventional additives (D) are an optional constituent of the inventive thermoplastic molding compositions.

Among these are by way of example stabilizers for improving resistance to the action of light, UV radiation and weathering (D1), stabilizers for improving heat resistance and thermo-oxidative resistance (D2), stabilizers for improving hydrolysis resistance (D3), stabilizers for improving acidolytic resistance (D4), lubricants (D5), mold-release agents (D6), colorant additives (D7), crystallization-regulating substances and nucleating agents (D8), impact modifiers (D9), fillers (D10), plasticizers (D11), and other conventional additives (D12).

Stabilizers for weathering and light and UV radiation (D1) that can be present in the inventive molding composition are one or more substances from the group of (D1A) benzotriazole derivatives, (D1B) benzophenone derivatives, (D1C) oxanilide derivatives, (D1D) aromatic benzoates, such as salicylates, (D1E) cyanoacrylates, (D1F) resorcinol derivatives, and (D1G) sterically hindered amines.

In one preferred embodiment, the inventive molding composition comprises not only at least one of the stabilizers of the groups (D1A) to (D1F), but also sterically hindered amines of the group (D1G).

In one particularly preferred embodiment, the inventive molding composition comprises a benzotriazole derivative (D1A) together with a hindered amine (D1G).

Examples of (D1A) benzotriazole derivatives are 2-[2′-hydroxy-3′,5′-bis(1,1-dimethylbenzyl)phenyl]benzotriazole, 2-[2′-hydroxy-3′-tert-butyl-5′-methylphenyl)-5-chlorobenzotriazole, 2-(2′-hydroxy-5′-methylphenzyl)benzotriazole.

Examples of benzophenone derivatives (D1B) are 2-hydroxy-4-n-octoxy-benzophenone and 2-hydroxy-4-n-dodecyloxybenzophenone.

Examples of sterically hindered amines (D1G) are 2,2,6,6-tetramethyl-4-piperidyl compounds, e.g. bis-(2,2,6,6-tetramethyl-4-piperidyl) sebacate or the polymer of dimethyl succinate and 1-(2-hydroxyethyl)-4-hydroxy-2,2,6,6-tetramethyl-4-piperidine.

The proportions used of the weathering stabilizers (D1) mentioned are advantageously from 0.01 to 2.0% by weight, based on the total weight of molding composition. Contents of from 0.02 to 1.0% by weight of at least one of the stabilizers D1A-D1G are particularly preferred.

The inventive molding composition can comprise, as stabilizers for improving heat resistance and thermo-oxidative resistance (D2), antioxidants (D2), e.g. one or more substances from the group (D2A) sterically hindered phenols, (D2B) phenol ethers, (D2C) phenol esters of organic or phosphorus-containing acids, examples being pentaerythrityl tetrakis[3-(3,5-di-tert-butyl-4-hydroxyphenyl)propionate], triethylene glycol bis[3-(3-tert-butyl-4-hydroxy-5-methylphenyl)propionate], 3-(3,5-di-tert-butyl-4-hydroxyphenyl)propionohydrazide, hexamethylene glycol bis[3-(3,5-di-tert-butyl-4-hydroxyphenyl)propionate], 3,5-di-tert-butyl-4-hydroxytoluene, (D2D) hydroquinones, and (D2E) aromatic secondary amines.

Preference is given to pentaerythrityl tetrakis[3-(3,5-di-tert-butyl-4-hydroxyphenyl)propionate], hydroquinones (D2D), and aromatic secondary amines (D2E).

One particularly preferred embodiment uses a sterically hindered phenol (D2B) together with a phosphorus compound. The proportions used of the antioxidants (D2) mentioned can be from 0.01 to 10% by weight, based on the total weight of molding composition. Contents of up to 2% by weight are preferred.

Particular preference is given to the combination of Ciba Irganox® 1010 with Irgafos® 126.

The inventive molding composition can therefore comprise, as stabilizers for improving hydrolytic resistance (D3), one or more anhydridic substances from the group of the (D3A) glycidyl ethers or (D3B) carbodiimides. Examples are mono-, di-, or, if appropriate, polyglycidyl ethers of ethylene glycol, propanediol, 1,4-butanediol, 1,3-butanediol, glycerol, and the trisglycidyl ether of trimethylolpropane. The amounts that can be used of the stabilizers (D3) mentioned can be from 0 to 3% by weight, based on the total weight of molding composition. Contents up to 1.0% by weight are preferred. Polymeric or monomeric carbodiimides are particularly preferred.

The inventive molding composition can therefore comprise, as stabilizers for improving acidolytic resistance (D4), acid-abstracting substances, that is to say one or more substances from the group of the nitrogen-containing compounds (D4A), of the alkaline earth metal compounds (D4B), or of the bases (D4C).

If the matrix comprises polyacetals or polymers which are similarly acid-labile, one preferred embodiment uses not only nitrogen-containing compounds (D4A) but also alkaline earth metal compounds (D4B).

Examples of nitrogen-containing compounds (D4A) and melamine, melamine-formaldehyde adducts, and methylolmelamine.

Examples of alkaline earth metal compounds (D4B) are calcium propionate, tricalcium citrate, and magnesium stearate.

Examples of bases (D4C) are Na₂CO₃, CaCO₃ and NaHCO₃.

The preferred proportions used of the acid scavengers (D4) mentioned are from 0.001 to 1.0% by weight. Acid scavengers in the form of mixtures can also be used.

The inventive molding composition can comprise, as lubricants (D5) or mold-release agents (D6), waxes, e.g. polyethylene waxes and/or oxidized polyethylene waxes, their esters and amides, or else fatty acid esters or fatty acid amides.

Preference is given to mixed ethylenebis(fatty acid amides) and montan wax glycerides.

The proportions preferably used of lubricants (D5) and mold-release agents (D6) are from 0.01 to 10% by weight, based on the total weight of molding composition. Contents of from 0.05 to 3% by weight are particularly preferred. Lubricants can generally also act as mold-release agents, and vice versa.

The inventive molding composition can comprise, as colorant additives (D7), colorant substances, these being known as colorants. These can be either organic or inorganic pigments, or else dyes.

There is no particular limitation on the pigments and dyes. However, pigments should be used which disperse uniformly in the molding composition and do not increase their concentration at interfaces or at individual domains, thus permitting provision of excellent color uniformity, color consistency, and mechanical properties.

By way of example, mention may be made of anthroquinone dyes and various pigments, such as carbon black, azo pigments, phthalocyanine pigments, perylene pigments, quinacridone pigments, anthraquinone pigments, indoline pigments, titanium dioxide pigments, iron oxide pigments, and cobalt pigments. Any desired suitable combination of colorant substances can also be used within the present invention. If carbon blacks are used, they are often found not only to act as colorants but to contribute to weathering resistance.

Total content of colorant substances is preferably from 0.05 to 10% by weight, particularly preferably up to 5% by weight, based on the total weight of molding composition. If contents are too low, the desired depth of color is often not achieved; higher contents are mostly unnecessary, and are economically unattractive, and sometimes impair other properties, such as the mechanical properties of the molding composition.

The inventive molding composition can comprise, as crystallization-regulating substances (D8), homogeneously or heterogeneously acting nucleating agents, i.e. one or more substances from the group of solid inorganic compounds and crosslinked polymers. Examples of (D8) nucleating agents are fumed silicon dioxide with or without surface modification, calcium fluoride, sodium phenylphosphinate, aluminum oxide, fine-particle polytetrafluoroethylene, valentinite, pyrophyllite, dolomite, melamine cyanurate, boron compounds, such as boron nitride, silicic acid, montmorillonite, and also organic modified montmorillonite, organic or inorganic pigments, melamine-formaldehyde condensates, and phyllosilicates.

In one preferred embodiment, the inventive molding composition comprises, as nucleating agent, talc or branched or partially crosslinked polymers.

Proportions used of nucleating agents are preferably from 0.0001 to 5% by weight, based on the total weight of the molding composition. Contents of from 0.001 to 2.0% by weight are preferred.

The inventive molding composition can moreover comprise additives (D9) which, as impact modifiers, have an advantageous effect on mechanical properties.

Total contents of from 0 to 20% by weight are preferred, based on the total weight of the molding composition.

Examples of these are particulate polymers, which are often elastomeric or comprise elastomeric components.

Preferred types of these elastomers are those known as ethylene-propylene (EPM) or ethylene-propylene-diene (EPDM) rubbers. EPM rubbers generally have practically no residual double bonds, whereas EPDM rubbers can have from 1 to 20 double bonds for every 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyl-tricyclo[5.2.1.0.^{2,6}]-3,8-decadiene, and mixtures of these.

Preference is given to 1,5-hexadiene, 5-ethylidenenorbornene and dicyclopentadiene.

The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also comprise dicarboxylic acids, such as maleic acid and fumaric acid, or derivatives of these acids, e.g. esters and anhydrides, and/or monomers comprising epoxy groups. These monomers comprising dicarboxylic acid derivatives or comprising epoxy groups are preferably incorporated into the rubber by adding to the monomer mixture monomers comprising dicarboxylic acid groups and/or epoxy groups.

Other preferred elastomers are emulsion polymers whose preparation is described, for example, by Blackley in the monograph “Emulsion Polymerization”. The emulsifiers and catalysts which can be used are known per se. In principle it is possible to use homogeneously structured elastomers or else those with a shell structure. The shell-type structure is determined by the sequence of addition of the individual monomers. The morphology of the polymers is also affected by this sequence of addition. Monomers which may be mentioned here, merely as examples, for the preparation of the rubber fraction of the elastomers are acrylates, such as n-butyl acrylate and 2-ethylhexyl acrylate, corresponding methacrylates, butadiene and isoprene, and also mixtures of these. These monomers may be copolymerized with other monomers, such as styrene, acrylonitrile, vinyl ethers and with other acrylates or methacrylates, such as methyl methacrylate, methyl acrylate, ethyl acrylate or propyl acrylate. The soft or rubber phase (with a glass transition temperature of below 0° C.) of the elastomers may be the core, the outer envelope or an intermediate shell (in the case of elastomers whose structure has more than two shells). Elastomers having more than one shell may also have more than one shell composed of a rubber phase. If one or more hard components (with glass transition temperatures above 20° C.) are involved, besides the rubber phase, in the structure of the elastomer, these are generally prepared by polymerizing, as principal monomers, styrene, acrylonitrile, methacrylonitrile, α-methylstyrene, p-methylstyrene, or acrylates or methacrylates, such as methyl acrylate, ethyl acrylate or methyl methacrylate. Besides these, it is also possible to use relatively small proportions of other comonomers.

The particles of the rubber phase may also have been crosslinked. Examples of crosslinking monomers are 1,3-butadiene, divinylbenzene, diallyl phthalate and dihydrodicyclopentadienyl acrylate, and also the compounds described in EP-A 50 265.

It is also possible to use the monomers known as graft-linking monomers, i.e. monomers having two or more polymerizable double bonds which react at different rates during the polymerization. Preference is given to the use of compounds of this type in which at least one reactive group polymerizes at about the same rate as the other monomers, while the other reactive group (or reactive groups), for example, polymerize(s) significantly more slowly. The different polymerization rates give rise to a certain proportion of unsaturated double bonds in the rubber. If another phase is then grafted onto a rubber of this type, at least some of the double bonds present in the rubber react with the graft monomers to form chemical bonds, i.e. the phase grafted on has at least some degree of chemical bonding to the graft base.

Examples of graft-linking monomers of this type are monomers comprising allyl groups, in particular allyl esters of ethylenically unsaturated carboxylic acids, for example allyl acrylate, allyl methacrylate, diallyl maleate, diallyl fumarate and diallyl itaconate, and the corresponding monoallyl compounds of these dicarboxylic acids. Besides these there is a wide variety of other suitable graft-linking monomers.

Instead of graft polymers whose structure has more than one shell, it is also possible to use homogeneous, i.e. single-shell, elastomers composed of 1,3-butadiene, isoprene, and n-butyl acrylate or of copolymers of these. These products, too, may be prepared by concomitant use of crosslinking monomers or of monomers having reactive groups.

Examples of preferred emulsion polymers are n-butyl acrylate-(meth)acrylic acid copolymers, n-butyl acrylate-glycidyl acrylate or n-butyl acrylate-glycidyl methacrylate copolymers, graft polymers with an inner core composed of n-butyl acrylate or based on butadiene and with an outer envelope composed of the abovementioned copolymers, and copolymers of ethylene with comonomers which supply reactive groups.

The elastomers described may also be prepared by other conventional processes, e.g. by suspension polymerization.

Other preferred rubbers are polyurethanes, polyether esters, and silicone rubbers.

It is, of course, also possible to use mixtures of the types of rubber listed above.

The inventive thermoplastic molding compositions can comprise, as fillers and reinforcing agents (D10), fibrous, lamellar, or particulate fillers and reinforcing agents.

Examples are carbon fibers, aramid fibers, glass fibers, glass beads, amorphous silica, asbestos, calcium silicate (wollastonite), aluminum silicate, magnesium carbonate, kaolin, chalk, lime, marble, powdered quartz, mica, baryte, feldspar, phyllosilicates and aluminosilicates, bentonite, montmorillonite.

The fillers may have been modified via organic components or silanization. The proportion of these fillers is generally up to 50% by weight, preferably up to 35% by weight.

The inventive molding composition can moreover comprise additives (D11) which affect the mobility of the chain in the amorphous phases or lower the glass transition temperature or act in some other way as plasticizer.

Examples are dioctyl phthalate, dibenzyl phthalate, butyl benzyl phthalate, hydrocarbon oils, N-(n-butyl)benzenesulfonamide, and o- and p-tolylethyl-sulfonamide.

The inventive molding composition can comprise, as other additives (D12), additives which as in the respective prior art provide or improve functional properties of the molding composition (e.g. electrical conductivity and/or antistatic performance).

An example of a method of production of the inventive molding composition or of a suitable intermediate product is the mixing of all of the constituents at an elevated temperature, i.e. above the softening or melting point of the, of some of the, or of all of the, matrix polymers (A) in assemblies with good mixing action, e.g. in Brabenders, extruders, preferably twin-screw extruders, or on mixing rolls.

Another method of preparation is the mixing of components at room temperature and subsequent melting of the matrix polymers in an extruder, preferably twin-screw extruder.

Another method of preparation is possible if the matrix A comprises a polymer whose structure derives from a polycondensation reaction: in this case, additives to improve dispersion can be added before the final molecular weight is achieved. Especially for nano-scale additives, this variant has advantages. If the matrix comprises a polyester, these and other components can be added at the end of the transesterification reaction or at the start of the polycondensation reaction.

The components can likewise, individually or in combination, first be processed to give relatively highly concentrated masterbatches, and these can then be further processed with other components to give the inventive mixture.

The additives mentioned for the purposes of this description can be added in any desired suitable steps. The final formulation of the molding composition can also be produced by delaying addition of individual additives, or of two or more additives, until shortly prior to production of the molding. Another suitable method is the mixing of pellets with an additive paste or the mixing of two or more types of pellets, where at least one corresponds to the inventive molding composition, or they finally combine to give the inventive constitution.

The inventive molding composition is thermoplastic and therefore accessible to the conventional methods of processing.

The usual method of processing uses pellets, these being further processed to give moldings in a known manner, e.g. via extrusion, injection molding, vacuum forming, blow molding, or foaming.

The inventive molding composition is suitable as a material for production of the semifinished product and of finished parts. The present invention also provides moldings in irradiated and unirradiated form which are produced from the inventive molding composition by means of conventional processing techniques, in particular via injection molding.

The inventive moldings can be used in the computer industry, electrical industry, electronics industry, household products industry, and motor vehicle industry.

Laser light can be used for marking and inscribing of inventive moldings, e.g. keyboards, cables, lines, decorative strips or functional parts in the heating sector, ventilation sector, and cooling sector, or switches, plugs, levers, and grips, comprising the inventive molding composition.

The inventive moldings can moreover be used as packaging.

The present invention moreover provides a process for laser-marking of thermoplastic moldings, encompassing the steps of:
i) production of a molding from a molding composition comprising a thermoplastic A), components B1) and/or B2), C) and, if appropriate, D) as defined above, and
ii) irradiation of predetermined parts of at least one surface of the molding with laser light in order to bring about a change in appearance at the irradiated sites.

The present invention likewise provides the use of the components B1) and/or B2) defined above for laser marking and of the components C) defined above for flame-retardancy of moldings.

A feature of the resultant markings is that they are resistant to wiping and scratching, stable during subsequent sterilization processes, and can be applied in a marking process under hygienically clean conditions.

The examples below illustrate the invention. No resultant restriction is intended.

### EXAMPLES

Specimens were produced and tested, comprising polybutylene terephthalate (PBT) as thermoplastic.

The matrix (A) used comprised Celanex® 2002 (Ticona GmbH), to give a total of 100%. Percentages in constitutions of substances mean % by weight.

If the example has the entry Cu as component B1), the light-sensitive compound used comprised 0.2% of copper hydroxide phosphate, purchased from Aldrich.

If the example has the entry Sn/Cu as component B1), the light-sensitive compound used comprised an additive powder which contains both stannous and cupric cations, purchased from Chemische Fabrik Budenheim KG. The additive was used in the form of unreacted mixture of the individual salts (about 80% of stannous phosphate with about 20% of cupric hydroxide phosphate) to prepare the molding compositions.

If the example has the entry Ti as component B2), the light-sensitizing oxide used comprised 1.0% of titanium dioxide in the form of 0.3 μm rutile, such as the Kronos grades 2078, 2900, or 2220. If the example has the entry Sb as component B2), the light-sensitive oxide used comprised 1.0% of antimony trioxide from Riedel-de-Haen or Campine.

If the example has the entry DEPAL as component C1, the phosphorus-containing flame-retardant additive used comprised 13.3% of aluminum diethylphosphinate (Exolit OP 1230) from Clariant. If the example has the entry RDP as component C1, the phosphorus-containing flame-retardant additive used comprised 5% of resorcinol tetraphenyl diphosphate.

If the example has the entry MC as component C2, the nitrogen-containing flame-retardant additive used comprised 6.7% of melamine cyanurate. If the example has the entry MPP as component C2, the nitrogen- and phosphorus-containing flame-retardant additive used comprised 5% of melamine polyphosphate.

Conventional additives D used comprised, as antioxidant, Irganox® 1010 and Irgafos® 126 (each Ciba), as nucleating agent talc, as flow aid and mold-release agent Licolub® FA1 (Clariant GmbH) or bisstearoylethylene-diamide, and as moisture abstractor Stabaxol® (Rheinchemie Rheinau GmbH).

The molding compositions were compounded in a Werner & Pfleiderer ZSK25 twin-screw extruder with two kneading zones.

The molding compositions were blended at from 250 to 280° C. in the twin-screw extruder, and extruded into a water bath. After pelletizing and drying, an injection-molding machine was used in accordance with ISO 7792-2 to produce test specimens and 1 mm plaques.

The fire test used complied with UL 94 (Underwriters Laboratories), on 1/32 inch test specimens. The UL 94 fire classifications are as follows:

V-0: afterflame time never longer than 10 seconds, total of afterflame times for 10 flame applications no more than 50 seconds, no flaming drops, no complete consumption of the specimen, afterglow time for the specimens never longer than 30 seconds after end of flame application
V-1: afterflame time never longer than 30 seconds after end of flame application, total of afterflame times for 10 flame applications not more than 250 seconds, afterglow time for the specimens never longer than 60 seconds after end of flame application, other criteria as for V-0
V-2: cotton indicator ignited by flaming drops; other criteria as for V-1.
>V-2: does not comply with fire classification V-2

If the example has been evaluated as “good” (+) in the fire classification column, the specimens achieved classification V-2, V-1, or V-0 in the UL 94 vertical fire test.

If the example has been evaluated as “unsatisfactory” (−) in the fire classification column, the specimens achieved classification >V-2 in the UL 94 vertical fire test.

A DPL Magic Marker from ACI Laser GmbH (Sömmerda, Thüringen) was used for laser inscription of the plaques, and the inscription parameters were varied as follows:

Pump intensities were varied from 40 to 90%, and pulse frequencies from 1 to 6 kHz, while horizontal advance rate and vertical line offset were selected so as to give 40, 50, and 75 μm cubic patterns.

To determine the optical properties of the matrix and markings, a Colorview II digital camera was used with analySIS Pro image-evaluation software from Soft Imaging Systems, mounted on a BX51 microscope from Olympus.

To determine lightness/darkness coordinates (along the black-white L axis), a micrograph was recorded using maximum reflected light, and this was converted to a gray-scale image and averaged across the region recorded. This method was used to obtain digital quantitative data from 0 for “black” to 255 for “white”. The images recorded for all of the specimens were made under identical conditions of illumination. The matrix and the laser markings were in each case separately recorded and evaluated.

To determine the color coordinates, a micrograph was recorded using maximum reflected light, and this was averaged across the region recorded, and the red, green, and blue components. This method was used to take digital quantitative data from 0 to 255 for the components of the three primary colors. The images recorded for all of the specimens were made under identical conditions of illumination. The matrix and the laser markings were in each case separately recorded and evaluated.

The results are used as a basis for the information collated in the table.

If the example has been evaluated as “good” (+) in the light-sensitivity column, pump intensities smaller than or equal to 50% and pulse frequencies greater than 4 kHz were sufficient to achieve adequate contrasts with intensity ratios >2.5 in marking fields.

If the example has been evaluated as “unsatisfactory” (−) in the light-sensitivity column, pump intensities smaller than or equal to 50% and pulse frequencies greater than 4 kHz gave inadequate contrasts with intensity ratios <2.5 in marking fields.

If the example has been evaluated as “moderate” (0) in the light-sensitivity column, the results were intermediate.

The table shows that the inventive molding compositions have no unsatisfactory evaluations, whereas all of the comparative examples have at least one criterion classified as unsatisfactory.

Comparative examples are indicated by “c”; inventive examples are numbered.

TABLE

| | | | | | | | D7 | D10 | Fire | Light |
|---|---|---|---|---|---|---|---|---|---|---|
| No. | A | B1 | B2 | C1 | C2 | D1/3/5/6/8 | (color: TiO₂) | (glass) | classification | sensitivity |
| 1 | PBT | Cu | | DEPAL | MC | 0.8% | 2% | 30% | + | + |
| 2 | PBT | Cu | Ti | DEPAL | MC | 0.8% | 2% | 30% | + | + |
| 3 | PBT | Cu | Sb | DEPAL | MC | 0.8% | 2% | 30% | + | + |
| 4 | PBT | Cu | Sn | DEPAL | MC | 0.8% | | 30% | + | + |
| 5 | PBT | Sn/Cu | Ti | DEPAL | MC | 0.8% | 2% | 30% | + | + |
| 6 | PBT | Cu | Ti | RDP | MPP | 0.8% | 2% | 30% | + | + |
| | | | | DEPAL | | | | | | |
| 7 | PBT | Sn/Cu | Ti | RDP | MPP | 0.8% | 1% | 30% | + | + |
| | | | Sb | DEPAL | | | | | | |
| 8 | PBT | Sn/Cu | Ti | RDP | MC | 0.8% | 2% | 30% | + | + |
| | | | | DEPAL | MPP | | | | | |
| 9 | PBT | Sn/Cu | Ti | DEPAL | MC | 0.8% | 2% | 30% | + | + |
| | | | | | MPP | | | | | |
| 10 | PBT | Sn/Cu | Ti | RDP | MC | 0.8% | 2% | 30% | + | + |
| | | | Sb | DEPAL | MPP | | | | | |
| | | | Sn | | | | | | | |
| comp. | PBT | Cu | Ti | — | — | 0.8% | 2% | 30% | − | + |
| comp. | PBT | | Ti | RDP | MC | 0.8% | 2% | 30% | − | − |
| comp. | PBT | | | RDP | MC | 0.8% | 2% | 30% | + | − |
| | | | | DEPAL | MPP | | | | | |

1. A laser-markable molding composition comprising
A) at least one thermoplastic and
B1) at least one particulate light-sensitive, inorganic compound of salt type which contains at least two cations, wherein one of said cations is selected from the group consisting of Ti, Cr, Mn, Fe, Co, Ni, Cu, Zn, Y, Zr, Nb, Mo, Ag, Sn, Sb, La, Pr, Ta, W, Ce and the corresponding anions are selected from carbonic acid anions and an anion having the general formula AₐOₒ(OH)_{y}^{z-}, where A is a tri- or pentavalent phosphorus, tetravalent molybdenum, or hexavalent tungsten,
a, o, and z, independently, are integers with values from 1 to 20, and
y is an integer from 0 to 10 wherein when exposed to laser light changes its color or leads to a change in the color of the polymer matrix,
C) at least one halogen-free compound which has a positive effect on the flammability and fire performance of the molding composition, and
D) optional other conventional additives.

2. The laser-markable molding composition as claimed in claim 1, wherein the proportion by weight of component A) is from 20 to 99.95% by weight, based on the total weight of the molding composition.

3. The laser-markable molding composition as claimed in claim 1, wherein component A) is selected from the group consisting of polyacetals, polyesters including polycarbonates, polyamides, polyarylene ethers, polyarylene sulfides, polyether sulfones, polysulfones, polyaryl ether ketones, polyolefins, liquid-crystalline polymers, and combinations with one or more of these polymers.

4.-5. (canceled)

6. The laser-markable molding composition as claimed in claim 5, wherein component B1) comprises at least one compound of salt type which has, as anions, phosphorus (V) and/or phosphorus (III) acid containing oxo anions.

7. (canceled)

8. The laser-markable molding composition as claimed in claim 1, wherein component further comprises at least one oxide which is based on at least one element selected from the group consisting of the 3rd-6th Periods of Groups II and III, the 5th-6th Periods of Group IV the 4th-5th Periods of subgroup III-VIII of the Periodic Table, the lanthanides, and cations of the elements of the 2^{nd}-5th periods of Group I.

9. The laser-markable molding composition as claimed in claim 8, wherein said oxide comprises titanium dioxide or antimony trioxide.

10. The laser-markable molding composition as claimed in claim 1, wherein component B1) has an average particle size smaller than 10 μm.

11. The laser-markable molding composition as claimed in claim 1, comprising at least one phosphorus-containing compound as component C).

12. The laser-markable molding composition as claimed in claim 11, wherein said compound is at least one salt of a phosphinic acid, of a diphosphonic acid, or polymers of phosphinic or diphosphonic acid as component C).

13. The laser-markable molding composition as claimed in claim 12, wherein said compound further comprises metal cations of the alkali metals, of the alkaline earth metals, or of the metals of main group 3 of the Periodic Table.

14. The laser-markable molding composition as claimed in claim 13, wherein said cations are selected from calcium and aluminum

15. The laser-markable molding composition as claimed in claim 12, wherein component C) comprises a compound having the structural unit of the formula I 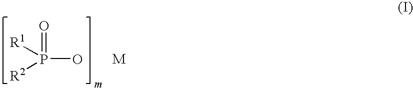
where R¹ and R², independently of one another, are hydrogen, alkyl, cycloalkyl, aryl, or aralkyl, M is an m-valent metal ion selected from alkali metal ion, alkaline earth metal ion, and an ion of a metal of main group 3 of the Periodic Table, and m is a whole number from 1 to 6, preferably from 1 to 3, and in particular 2 or 3.

16. The laser-markable molding composition as claimed in claim 12, wherein component C) comprises a compound having the structural unit of the formula II 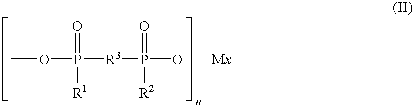
where R¹ and R², independently of one another, are hydrogen, alkyl, cycloalkyl, aryl, or aralkyl, and R³ is alkylene, cycloalkylene, arylene, or aralkylene, M is an m-valent metal ion selected from alkali metal ion, alkaline earth metal ion, and an ion of a metal of main group 3 of the periodic table of the elements, and n is a whole number from 1 to 6, preferably from 1 to 3, and in particular 2 or 3, and x is 1 or 2.

17. The laser-markable molding composition as claimed in claim 11, wherein said phosphorus-containing compound is selected from the group: tetraphenyl diphosphate, melamine phosphate, and melamine polyphosphate.

18. The laser-markable molding composition as claimed in claim 1 wherein component C is a nitrogen containing compound.

19. The laser-markable molding composition as claimed in claim 18, wherein said nitrogen-containing compound is a heterocyclic compound.

20. The laser-markable molding composition as claimed in claim 18, wherein said nitrogen-containing compound is selected from the group: melamine cyanurate, melamine phosphate, and melamine polyphosphate.

21. The laser-markable molding composition as claimed in claim 1 said component C is a compound containing hydroxy groups.

22. The laser-markable molding composition as claimed in claim 21, wherein said hydroxy group containing compound is selected from the group: polyvinyl alcohol, sorbitol monostearate, and poly(ethylene-co-vinyl alcohol).

23. The laser-markable molding composition as claimed in claim 1 further comprises pelletized melamine cyanurate which comprises from 0.5 to 1.5% by weight of polyvinyl alcohol.

24. The laser-markable molding composition as claimed in claim 1 wherein component C) is an inorganic compound.

25. The laser-markable molding composition as claimed in claim 24, wherein said inorganic compound is selected from the group of the oxygen compounds of silicon, of the oxides or salts of magnesium, calcium, aluminum, or zinc, or stannates or borates.

26. The laser-markable molding composition as claimed in claim 25, wherein said inorganic compound is a metal borate of metals of the first, second, or third main group or of the second transition group of the periodic table of the elements.

27. The laser-markable molding composition as claimed in claim 26, wherein said metal borate has the formula III
iMgO.kCaO.lAl₂O₃.mZnO.nB₂O₃.oH₂O (III)
where i, k, l, m, n, and o are numbers from 1 to 14.

28. The laser-markable molding composition as claimed claim 1 wherein the proportion by weight of component B1) is from 0.1 to 10% by weight, based on the total weight of the molding composition.

29. (canceled)

30. The laser-markable molding composition as claimed in claim 1, wherein the proportion by weight of component C) is from 1 to 50% by weight, based on the total weight of the molding composition.

31. The laser-markable molding composition as claimed in claim 11, wherein the proportion by weight of the phosphorus-containing component is from 0 to 40% by weight, based on the total weight of the molding composition.

32. The laser-markable molding composition as claimed in claim 18, wherein the proportion by weight of the nitrogen-containing component is from 0 to 30% by weight, based on the total weight of the molding composition.

33. The laser-markable molding composition as claimed in claim 21, wherein the proportion by weight of the component containing hydroxy groups is from 0 to 30% by weight, based on the total weight of the molding composition.

34. The laser-markable molding composition as claimed in claim 24, wherein the proportion by weight of the inorganic component is from 0 to 30% by weight, preferably from 0 to 20% by weight based on the total weight of the molding composition.

35. The laser-markable molding composition as claimed in claim 12, wherein the proportion by weight of a phosphinic salt of the formula (I) 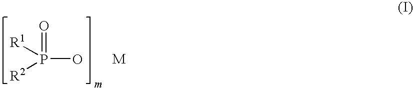
or of a diphosphonic salt of the formula (II), and/or polymers thereof 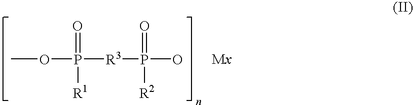
is from 1 to 40% by weight, based on the total weight of the molding composition.

36. The laser-markable molding composition as claimed in claim 1, wherein the proportion by weight of other additives D) does not exceed 50%, based on the total weight of the molding composition.

37. The laser-markable molding composition as claimed in claim 1 wherein said D) is selected from stabilizers for improving resistance to the action of light, UV radiation and weathering, stabilizers for improving heat resistance and thermo-oxidative resistance, stabilizers for improving hydrolytic resistance, stabilizers for improving acidolytic resistance, lubricants, mold-release agents, colorant additives, crystallization-regulating substances, and nucleating agents, impact modifiers, fillers, and plasticizers.

38. A process for laser-marking of thermoplastic moldings, encompassing the steps of
i) production of a molding from a molding composition comprising at least one semicrystalline thermoplastic A) and components B1) and also C) and, if appropriate, D), as claimed in claim 1, and
ii) irradiation of predetermined parts of at least one surface of the molding with laser light in order to bring about a change in appearance at the irradiated sites.

39. A molding obtainable via shaping of a laser-markable molding composition of claim 1.

40. A laser-marked molding obtainable via irradiation of a molding composed of a laser-markable molding composition as claimed in claim 1, using laser light.

41. (canceled)
